(19) United States
(12) Patent Application Publication
(10) Pub. No.: US 2002/0059205 A1
(43) Pub. Date: May 16, 2002

(54) On-line facilities management tool

(76) Inventors: James J. Graham, Fort Collins, CO (US); Dallen Campbell, Loveland, CO (US)

Correspondence Address: Cochran & Collins LLP, Suite 230, 3555 Stanford Road, Fort Collins, CO, 80525, US

(21) Appl. No.: 09/905,627

(22) Filed: Jul. 13, 2001

Related U.S. Application Data
(60) Provisional application No. 60/217,905, filed on Jul. 13, 2000.

(51) Int. Cl. G06F 7/00

(52) U.S. Cl. 707/3

(57) ABSTRACT

The present invention is a system for assisting a manager of a sporting event or sporting facility in scheduling and managing the event or facility. The invention aids in scheduling league or tournament play and creates a website for helping registration, disseminating league or facility schedules or other information, keeping track of ongoing statistics, and adjusting schedules after the season or tournament starts.

### CROSS REFERENCE TO RELATED APPLICATIONS

This application claims the benefit of U.S. Provisional Application serial No. 60/217,905, entitled “On Line Management Tool for Facilities” filed Jul. 13, 2000.

### BACKGROUND OF THE INVENTION

a. Field of the Invention

The present invention pertains generally to a computerized scheduling tool and specifically a computerized scheduling tool utilizing the world wide web and incorporating features for sporting events scheduling.

b. Description of the Background

Common scheduling tools rely on simple, but very limited sets of rules for scheduling events. These rules generally take the form of sequencing requirements and for example, state that a certain event must take place before a second event or that two events may be done in parallel. These types of scheduling programs are generally devoted to commercial applications such as machine tool scheduling, project planning and the like.

The scheduling of sporting leagues and tournaments is a difficult and arduous task, especially when interrelated parameters must be followed. For example, a person who schedules a series of events, such as a hockey league, must schedule blocks of time with the ice rink facility, then manually determine which teams are supposed to play at which times, on which sheet of ice, which locker rooms to use, which officials to officiate which games, etc. Further, the tournament scheduler must make sure that one team does not consistently get the favored early start times on the indoor sheet of ice with warm locker rooms and others are relegated to the 2:00am start time on the outside rink while dressing in the middle of a howling wind.

Once the schedule is set, it is often distributed on paper to the participants. If a change to the schedule must be made, for example if a team drops out of the league, the reshuffling of the schedule and the communication of the new schedule to the participants is difficult and prone to error. Further, it is often the league manager's responsibility to contact participants via phone or in person to make sure the participant knows when to attend their first game.

It has become popular to have schedules and such posted on a website. The scorekeeping and subsequent maintenance of a website of the schedules is often a tedious and time-consuming task. Because of the difficulty in this task, it is rare that a website is maintained for a tournament. If the website is not maintained, the website is much less likely to be used by the participants and therefore serves little purpose.

One of the jobs of the league manager is to collect funds from each participant and to ensure that the participant has met their financial obligations. It is common for leagues that extend over a long period of time to have an option of paying at certain stages throughout the season. Debt collection is often one of the more time consuming and least favorite jobs of the league manager.

It would therefore be valuable to provide an on line method for scheduling a series of sporting events wherein a tournament scheduler may us a computer network to create and maintain a database of participants, book time at one or more sporting facilities for the event, have automated assistance in creating a schedule of competition, and create and maintain a website for the sporting events. Further, such a system would be more valuable if it were able to collect funds from participants and to remind them to pay their fees at scheduled intervals.

### SUMMARY OF THE INVENTION

The present invention overcomes the disadvantages and limitations of the prior art by providing a computer system for automatically scheduling a large sporting event and keeping track of all the scheduling for a sports facility. Further, the invention provides a method of accessing the scheduling computer worldwide and for easy dissemination and immediate updates for the participants in the events.

The computer system allows managers of sports leagues to book time from the sports facility, set up league play based on scheduling rules, and quickly create a schedule for each participant. The computer system interface is through the World Wide Web, allowing the manager to perform this function from anywhere in the world.

The participants in the league may retrieve their particular schedules from a separate web interface and can simply be in formed via email of their schedules. Reminders can also be sent via email before each competition.

Further, the manager is able to easily manage the league during the course of the season. The manager can easily update scores and results as the league progresses, and the manager has the ability to adjust the schedule as the league progresses, for example if several games are rained out, they can either be rescheduled or the entire schedule can be adjusted so that the teams play each other an equal number of times.

The participants in the league may view the current statistics in their league at any time and from any location during the play of the league. The league website can become a virtual watering hole where league participants can use a discussion board, check up on their statistics and their friend's statistics, and find out about other events at the facility. Since the website is updated frequently and automatically, the usefulness of the website is greatly enhanced.

The manager also has the opportunity to schedule tournaments, such as a conventional bracket, or single elimination tournament, or a double elimination tournament, king of the hill tournament, or any other type of tournament one can imagine. The difference with tournament and league play is that the game time and participants are not able to be determined until each round of tournament play is complete. By using the inventive system, players who did not hear about the playoff results by word of mouth will be able to access the information via the web interface, placing a much smaller burden of communication on the league manager.

The general manager of the facility has a centralized computer database for scheduling different events for the sports facility. Birthday parties, open sessions, family nights, preventative maintenance, and other non-competitive scheduled activities can be scheduled and displayed using the same web based interface as the competitive activities. Further, the public web interface that the participants in the competitive activities access to find their schedules and statistics serves as the same web interface for the general public. The public web interface has a complete schedule of all the activities at the facility, any notices, special announcements, promotions, directions to the facility, local lodging, or any other information that would be helpful to prospective or returning visitors.

The inventive system has the ability to collect funds from each participant and to track people who are delinquent in their accounts. This eliminates a large time sink and a source of discontent, frustration, and embarrassment for the league manager and participant.

The present invention may therefore comprise a method of creating a schedule for a sports competition using a computer comprising: having a database of teams; selecting the scheduling parameters for competition; automatically calculating the individual games between each team; and displaying the schedule.

The present invention may further comprise a computer system for scheduling of sports competitions comprising: a database of participants, an automated program for matching participants in games based on a set of rules and thereby creating a schedule of competition, and a display that provides scheduling information.

The present invention may further comprise a computer system for managing a sports facility comprising: a web server, a database comprising the schedule for the facility, a web-based interface for accessing and reserving time in the database The advantages of the present invention are that the league manager's job of scheduling, bookkeeping, and communication are all greatly reduced, leaving the manager to focus on other issues with running their league. The manager's scheduling job is largely automated and has tools to help the manager reschedule or manually change the schedule as necessary. The bookkeeping is significantly reduced because the participants are encouraged to sign up for a league on line. At the same time, the participant may pay their fees that are collected and deposited automatically. The communication burden on the league manager is drastically changed since email distribution of schedules and other announcements may be made quickly and efficiently, as opposed to the old method of printing flyers and distributing them at the next game. Further, the participants can use the website to view the schedule and any announcements without having to call the league manager or other participant.

The participants of the league are better informed during the course of the league and have a common place to gather and share information and stories as the league progresses. Further, the participants can obtain league information at any time and at any place, increasing their convenience. The participants have a sense that the league is well organized and efficient and are more likely to return for future seasons if they feel like their needs are better being met by the league manager and the facility.

The sports facility benefits from the inventive system because the league managers can handle much of the tedious burden of finding available times and booking that time. Further, it is possible for anyone in the general public to book a special event such as a birthday party or practice session and pay with a credit card without having to interact with the staff. This has a two fold benefit: one is that the staff is not burdened with communicating open times to the person wanting to book the time, and second, the person booking the time can view the entire schedule and book the event with the convenience and simplicity of a short web session, making it more likely that the unused time slots will be filled by paying customers. Further, the facility has a prestigious website that their customers will use over and over, allowing the facility to promote special offers and more participation from their customer base.

### BRIEF DESCRIPTION OF THE DRAWINGS

In the drawings,

FIG. 1 is an illustration of an embodiment of the invention comprising a block diagram of the invention.

FIG. 2 is an illustration of an embodiment of a scheduling method.

FIG. 3 is an illustration of a round robin schedule for four teams.

FIG. 4 is an illustration of a single elimination tournament bracket for four teams.

FIG. 5 is an illustration of a double elimination tournament bracket for four teams.

FIG. 6 is a second illustration of a double elimination tournament bracket with results.

FIG. 7 is an illustration of an embodiment of the invention showing access points through the Internet.

FIG. 8 is an illustration of an embodiment of the inventive process for creating a schedule.

### DETAILED DESCRIPTION OF THE INVENTION

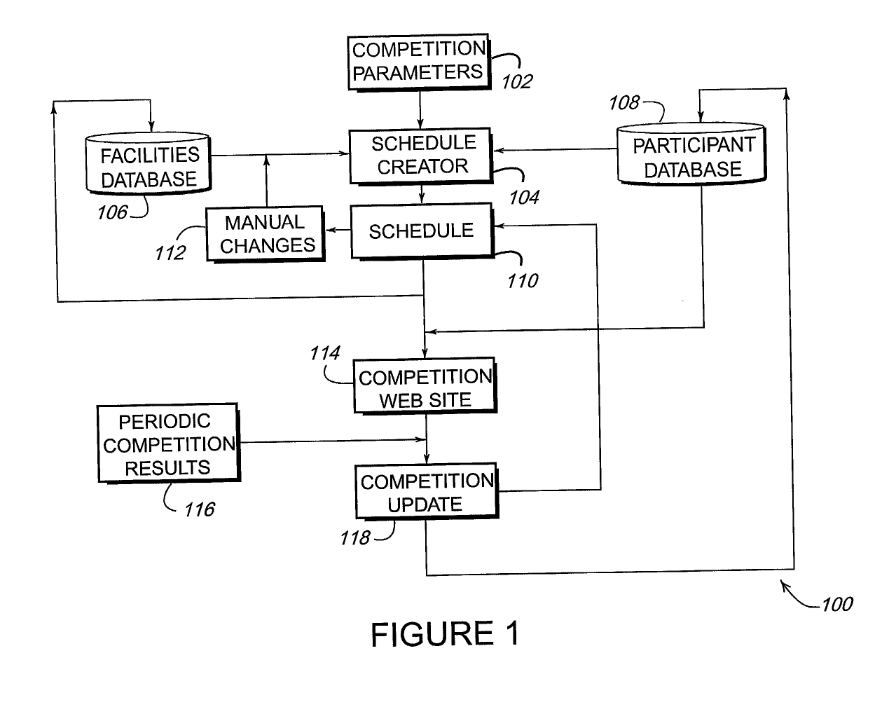

FIG. 1 is an illustration of an embodiment of the inventive system 100 and illustrates the steps that occur from a league manager's perspective. The system 100 comprises a set of competition parameters 102 that feeds into the schedule creator 104, which obtains information from the facilities database 106 and participant database 108. The output of the schedule creator 104 is a schedule 110, which is optionally changed by the manual changes 112 that feeds back into the schedule creator 104. The schedule 110 feeds the competition website 114. Periodic competition results 116 feeds the competition updater 118, which in turn update the schedule 110 and the participant database 108.

The inventive system 100 is designed to operate for any sporting event where facilities must be scheduled. This would include facilities such as rinks for ice skating and roller skating; race tracks for motor sports, bicycling, boat racing, airplane racing; courts for basketball, racquetball, handball, squash, tennis, badminton, volleyball; golf courses; health clubs; curling facilities; bowling lanes; boxing rings; facilities for martial arts competitions; ranges for archery and shooting; facilities for ballooning, kayaking, beauty contests, equestrian events, fishing tournaments, tossing the caber, sheaf toss, hammer throwing, pearl diving, chess tournaments; fields for baseball, football, soccer, rugby, cricket, polo, lacrosse; facilities for billiards, darts, table tennis, pinball or other arcade games; facilities for track meets, swim meets; facilities for crew races, and many other facilities. This list is for example only and not meant to limit the inventive system 100. Others skilled in the art of competitions may be able to expand this list while maintaining within the scope of the invention.

The inventive system 100 may run on a stand alone computer system or on a server computer that has a web enabled interface for all input and output functions, including displaying the results.

Competition parameters 102 comprise the information necessary to create a schedule 110. The parameters 102 include the dates and times of the competition, the venues of competition, type of competition program, sport to be played, number of teams involved, and other parameters particular to the sport or even that is scheduled.

The competition program that is to be scheduled may take on many forms. The competition program may be a league wherein several teams compete against each other for a specific length of time or season. The competition program may be a tournament that includes a number of teams competing over a weekend. Further, the competition program may be a practice session, which is a period where only one team may be scheduled for a time slot. The competition program may also be a party, open period, maintenance period, or other event where the facility is scheduled for a certain period of time. The competition program may comprise multiple instances of scheduled programs, such as a tournament or a league. The competition program may comprise only one instance, such as a single practice session or a party. The term competition program is meant to include any period of time, including recurring periods of time that are scheduled for the facility and should not be constrained to include those of only a competitive nature.

When a schedule for a competition program is created, several parameters must be compared to existing schedules in the facility database 106. These parameters may include the dates, times, and venues requested by the league manager. The league manager may request a date and time that conflicts with an existing event already scheduled. In this case, the manager may elect to change the date, time, or venue or cancel or skip one or more instances of the competition program.

The facility database 106 may be part of a computerized system for scheduling an entire facility, of which the inventive scheduling system 100 is an integral part. Optionally, the facility database 106 may be a fixed set of available times and not be a part of a scheduling system used for an entire facility. In this case, the inventive system 100 may be primarily adapted to assist a league manager in the administrative functions of running a league or tournament.

The participant database 108 may comprise individual and team data. Individual data may include personal data such as addresses, phone numbers, age, gender, etc. Individual data may also include data that relates specifically to the sport being played. For an example of an ice hockey league, the data may include position played, overall ranking, number of goals scored, penalty minutes, plus/minus rating, or any other statistics that the league manager would like to keep. Individual data may also include an account for keeping track of payment history.

Team data may comprise general data, sport specific team data, and financial data. The general data may include team name, sponsor, coach, captain, mailing address, and team members. Specific team data, in the ice hockey example may include win/loss record, goals for, goals against, pair wise rankings, or other data. Financial data may include an account for keeping track of payment history of the individual team. For some leagues, the facility may charge a fixed fee per team or may charge a fixed fee per individual player.

For individual sports, such as a martial arts tournament, the teams may consist of individual players that are scheduled in individual events. In this case, the team statistics may be a compilation of individual statistics or other statistics adapted to the particular sport.

The data stored in the participant database can contain different information for different people who participate at the facility. For example, the database file for a captain of a hockey team may have all his or her personal information, their complete statistics for all their years of playing, statistics for each of the leagues in which he or she participates, credit card information for booking practice sessions, amongst other data that might be kept. For a participant who schedules time at the facility, for example, to teach figure skating, the database entry may consist of merely name, address, phone number, and credit card information.

The database for multiple facilities may be combined so that a user who is registered at one facility may link his or her data to another facility. This provides the user a simpler method for registering at different locations. Further, the statistics database may include the participant's global statistics as well as their statistics for the local facility.

The facility may make use of the participant database to advertise and promote goods and services to the participants. The facility may use the database to mail or email fliers for upcoming leagues, tournaments, shows, and other events at the facility. These may be selectively chosen based on the participant's interest and history at the facility. The facility may also promote sales of equipment for the sport that the participant plays by sending brochures and catalogs from the facility's equipment store or by selling the participant list to outside businesses that sell such equipment.

The statistics kept for each team or player may be consolidated across several facilities to generate statistics for regional, nationwide, or worldwide areas. Using the hockey example, if teams are playing in multiple facilities against multiple teams over a period of time, pair wise rankings can be established for these teams. Pair wise rankings is a method of ranking teams based on how well they played against other teams, with wins against strong opponents boosting the ranking and loses against weak opponents dropping the ranking. Their win/loss record or other criteria may calculate the strength of the opponent. To continue with the hockey example, individual statistics may be also consolidated across multiple facilities, such as determining the best goal scorer or best goalie over a period of time.

The facility may have several sports using the same venue, each of which has different scheduling, statistical, and other parameters tailored to the needs of that particular sport. For example, an ice rink may host hockey, speed skating, and figure skating competitions on the same sheet of ice. When the user selects a specific sport as part of the parameters 102, the participant database, scheduling algorithms such as round robin play, and website applicable to that sport will be used.

The schedule creator 104 takes all of the parameters 102 and the data from the facilities database 106 and participant database 108 and creates a schedule 110. The schedule creator may be tailored to individual sports and may create several different types of schedules, such as round robin matches, single elimination tournaments, double elimination tournaments, and other types of match play. The schedule creator 104 may be a fully automated process or may be a manual process whereby each event is individually entered by hand.

The schedule 110 may be manually changed or manipulated after creation as illustrated by the manual changes 112. The schedule 110 may have to be changed because of some events, for example, being cancelled for weather or emergency maintenance and must be rescheduled.

The competition website 114 is a method for display of the current schedule 110. The website 114 may comprise advertisement, league notes, discussion boards, etc. The portion of the website 114 which includes the schedule 110 may be made available to the general public, or may be restricted to only participants, only to coaches, or only to people designated by the league manager, for example. The restrictions placed on the data can be tailored for a specific application and may be changed or adjusted without deviating from the scope of the invention.

The website 114 may further comprise a means for sorting and displaying data from the participant database 108. For example, the participant database 108 may be used to display team statistics for wins, losses, goals for, goals against, pair wise rankings, etc. Further, the individual statistics for leading goal scorer, most penalty minutes, and other categories may also be searched, sorted, and displayed. Personal data on participants may also be made available, but the data may be restricted. For example, a team member may be able to get phone numbers for other team members or a captain of a team may be able to find out who has paid and who has not.

As competition progresses through various events, periodic competition results 116 can be entered to the system 100. The competition updater 118 processes the results 116, then sends updates to the schedule 110 and participant database 108. The results 116 may comprise the score of a particular event and any team and individual statistics that resulted from the event. The results sent to the schedule 110 may include the event completion and the specific results to be displayed in the schedule 110 on the website 114. The results from the updater 118 may be fed into the schedule 110 and database 108 and are then available immediately via the website 114.

For the purposes of a round robin league play, the schedules for each team, including the venue and time, are determined at the point that the schedule 110 is created. For the purposes of a tournament, the initial seeding of the teams for the first round of play is known, however, the teams for the subsequent rounds are determined by the results of the previous round. Therefore, the updating of the schedule and public availability of the schedule information via the World Wide Web can be of great importance and usefulness to the participants of the tournament. Further, email notices can be sent to each participant when the next games are finalized.

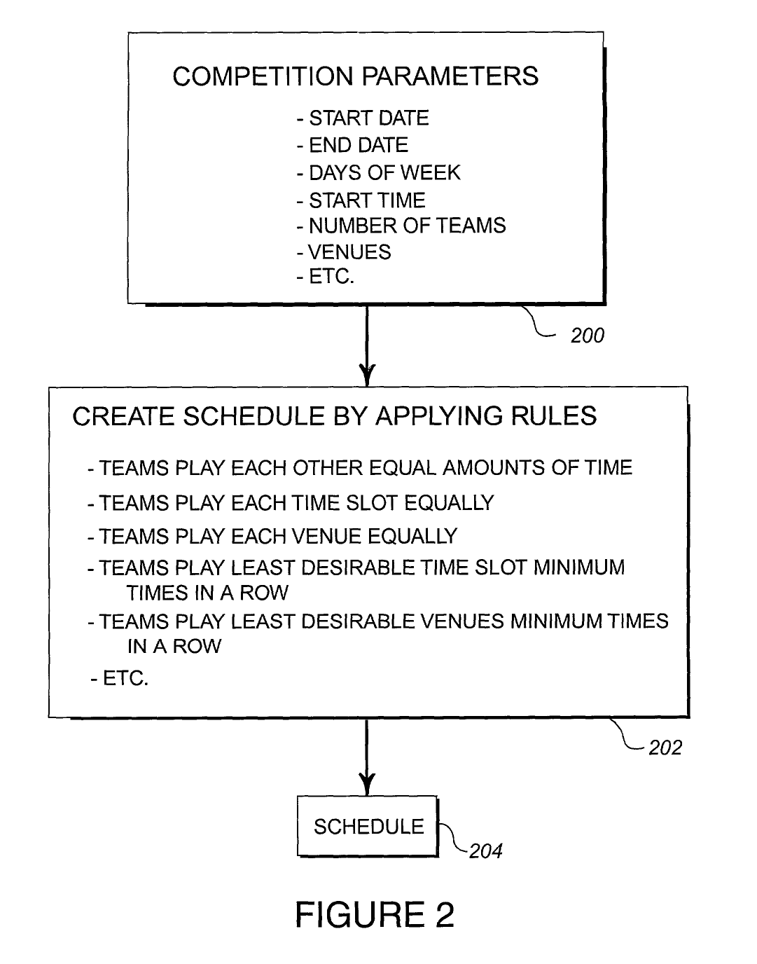

FIG. 2 illustrates an embodiment of the scheduling process and rules used to create schedules. The input parameters 200 are used by the rules 202 to create a schedule 204. The input parameters 200 may include such factors as the start date, end date and days of the week for scheduling of multiple games of a league, for example. The start time and number of teams can be used to calculate the number of time slots required. Additionally, the length of time for each event may be entered, as well as any period of time allocated between events. The period between events may be for the cleaning of the showers and locker rooms, for resurfacing of the playing surface, or for whatever purpose as needed for the particular sport. The venues may also be selected as an input to the schedule, and multiple venues may be selected for the same league. For example, a baseball park may have four fields for softball that are scheduled simultaneously for a softball league. For each application of the invention, a particular sport or facility may have its own parameters by which a manager may wish to schedule events, and those managers or others skilled in the art may add or delete parameters to suit their application while still maintaining within the scope of the present invention.

The rules 202 are the method for selecting the appropriate matches of teams against each other. The set of rules to apply to the generation of each schedule may be different, and may be set by the league manager or facility owner based on their particular situation. The rules 202 are illustrated as examples only. In a round robin league play example, the schedule should be such that teams play each other an equal amount of times, teams should play each time slot equally, teams should play each venue equally, etc. For leagues where the number of teams does not afford each team to play every other team exactly the same amount of times, the scheduler will come as close as possible. There are additional rules that can be created for each type of venue and sport, and the selection of which rule to apply and the priority of rules can be a part of the competition parameters 200. The specific rules for each facility, sport, and venue may be created specifically for that application.

It is possible that the rules 202 over constrain the results. In this case, an algorithm may be to prioritize the rules to ensure that a solution can be found. There exist various algorithms that may be applied to find a solution as needed.

The schedule 204 that comes out of the rules 202 is typically in a form that can be displayed on a website or that can be printed on paper. The form of the schedule and the data it contains can be modified by those skilled in the art without deviating from the scope and intent of the present invention.

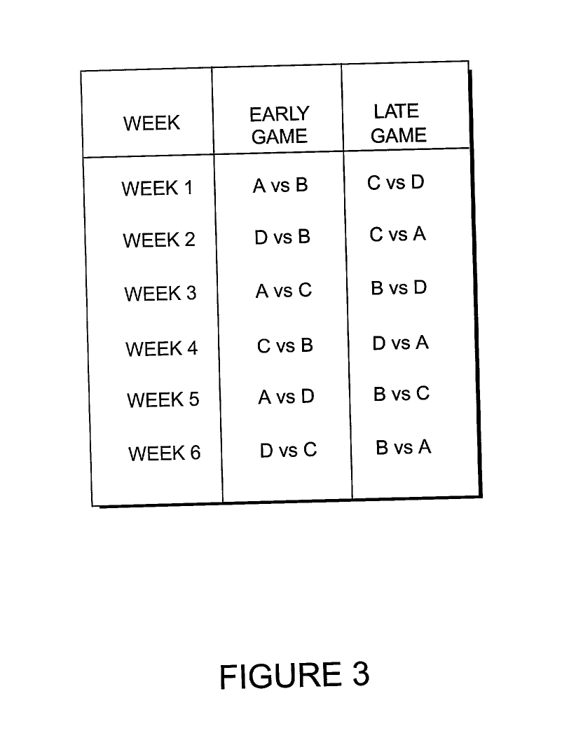

FIG. 3 illustrates an example of a schedule created by the rules shown in FIG. 2. The vertical axis is the various weeks of the league; in this case there are six weeks in the league. There are four teams in the league and two games are played each week. Each team has three games as the home team and three games as the away team. Further, each team plays three games at the early time slot and three games at the later time slot. Each team plays every other team twice and no team plays in the later time slot more than twice in a row.

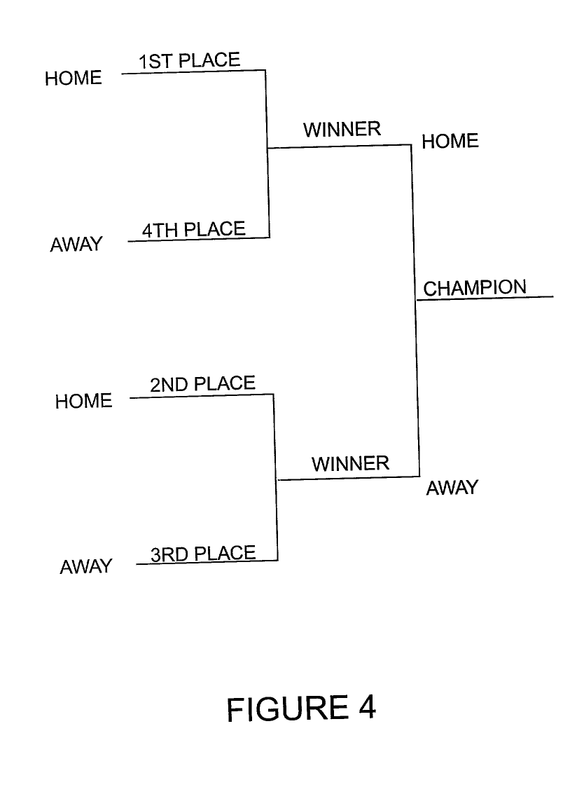

FIG. 4 illustrates an example of a single elimination tournament bracket for four teams. In a single elimination bracket, once a team loses, it is eliminated from further competition. Only the winners advance to the next round until a champion is chosen. In the example, the first place seed plays the fourth ranked seed, and the second place seed plays the third ranked seed. Teams may be ranked based on round robin match play, luck of the draw, or any other criteria. In general, the ranking system provides a mechanism whereby the team with the best record coming into the tournament has the advantage of playing the worst teams throughout the bracket. Those teams at the bottom of the ranking must win against the best teams to advance, providing an incentive to perform well during the regular season prior to the tournament. For tournaments where there is a number of teams which do not equal 2 to an integral power, empty slots will be used to fill in the brackets. Teams that are scheduled to play against an empty slot will advance to the next round. This is known as a ‘bye’ round.

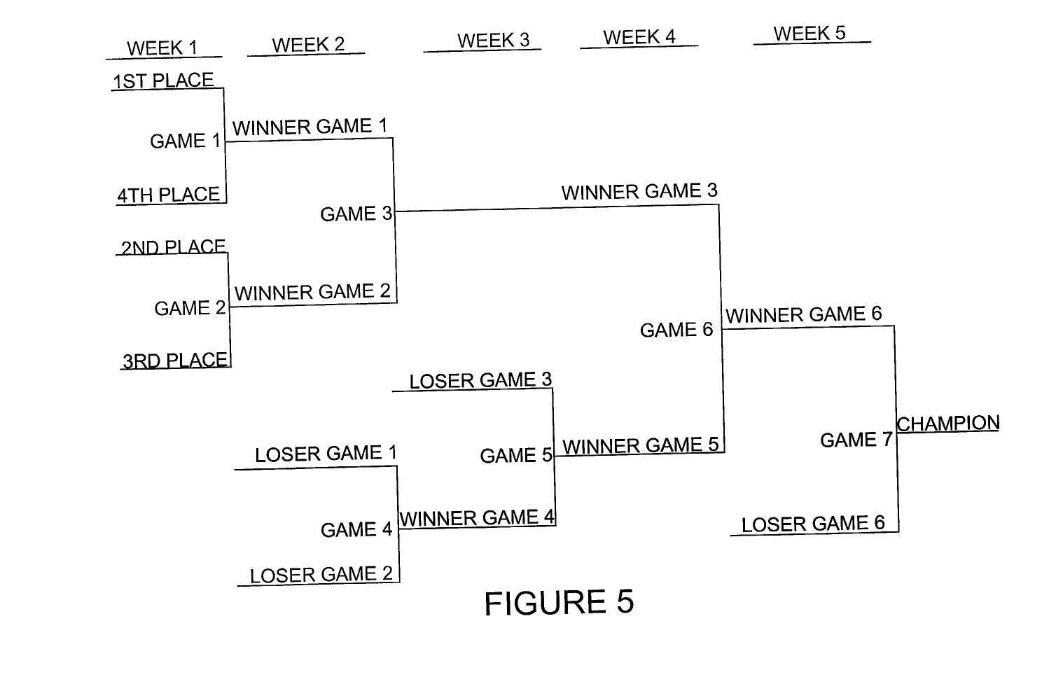

FIG. 5 illustrates an example of a double elimination tournament for four teams. In a double elimination tournament, when a team loses twice, it is eliminated from further competition. For the example of four teams, the teams are seeded similarly to the example of a single elimination bracket, with the best team playing the worst in the first game. After the first set of games, the winners of each of the first two games play each other and the losers of the first two games play each other. After the second set of games, one team has lost twice and is therefore eliminated, leaving three teams. In week three, the winner of Game 3 has not yet lost and is awarded a bye to the next round. Game 5 has the remaining two teams playing, the loser of which will have lost twice and therefore be eliminated. Game 6 poses the winner of Game 3, who has never lost, against the winner of Game 5, who has lost once. If the winner of Game 3 prevails over the winner of Game 5, the loser will have lost twice and therefore be eliminated and the winner will be champion. If the winner of Game 3 does not prevail, both of the teams will have lost only once and must play again for the championship.

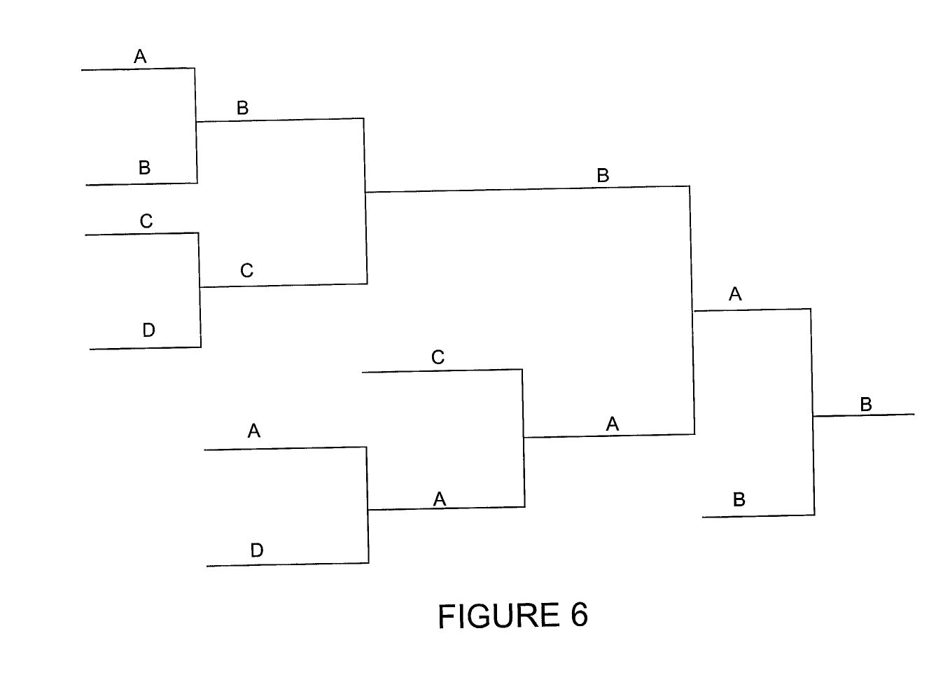

FIG. 6 illustrates an actual tournament that was won by team B. Letters A, B, C, and D represent various teams entered into the tournament. At the end of the second round, team D had lost twice and was eliminated. In the third round, team C was eliminated by A, who played B in the fourth round and prevailed. Since A and B had only lost once, a championship game was needed to decide the overall victor, which B won.

In practice, the double elimination tournament guarantees each team at least two games and gives a loser of one game a chance of still winning the championship. Every sport has variations on the types of tournaments that are customary. Some sports, such as bowling, have tournaments that are ‘king of the hill’ style where a fourth ranked player must face the third ranked player, and the winner faces the second ranked player, and the winner faces the first ranked player to decide the championship. Many other methods of tournaments and competitions exist and can be implemented in the present invention by those skilled in the art without deviating from the scope and intent of the present invention.

During the course of a tournament, the schedule for which teams are going to play is determined as the tournament progresses. In this case, it is critical that each participant be informed as to when the next game is going to take place and where the game is located. Often, this is done by word of mouth or must be communicated by telephone if the participant is not present at a meeting. The present invention gives all participants a method of finding the tournament schedule immediately and conveniently through a web interface.

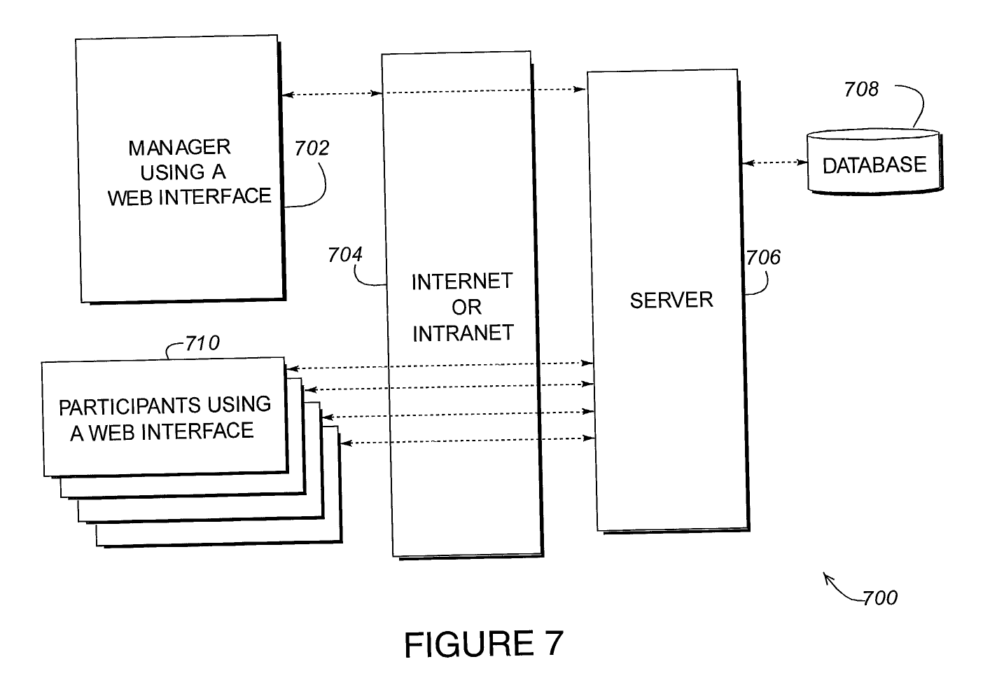

FIG. 7 illustrates an embodiment 700 of the invention whereby a manager of a league 702 is able to use a web interface over the Internet or an intranet 704 to a server computer 706 which in turn accesses a database 708. Multiple participants 710 may also access the server 706 via a web interface to the Internet or intranet 704. The web interfaces may use HTML or other language to display and collect data.

Embodiment 700 may supply scheduling and web services for one or more facilities. In the case of a server for several facilities, the web site look and feel may be completely different between facilities; however, a common database 708 may be used. By using a common database between facilities, it is much easier to establish links for participants that use multiple facilities. When a participant is linked to more than one facility, the statistics that are displayed for that participant may include statistics for the aggregate of all the facilities or only a single facility. Further, the participant only needs to register and enter their personal data once.

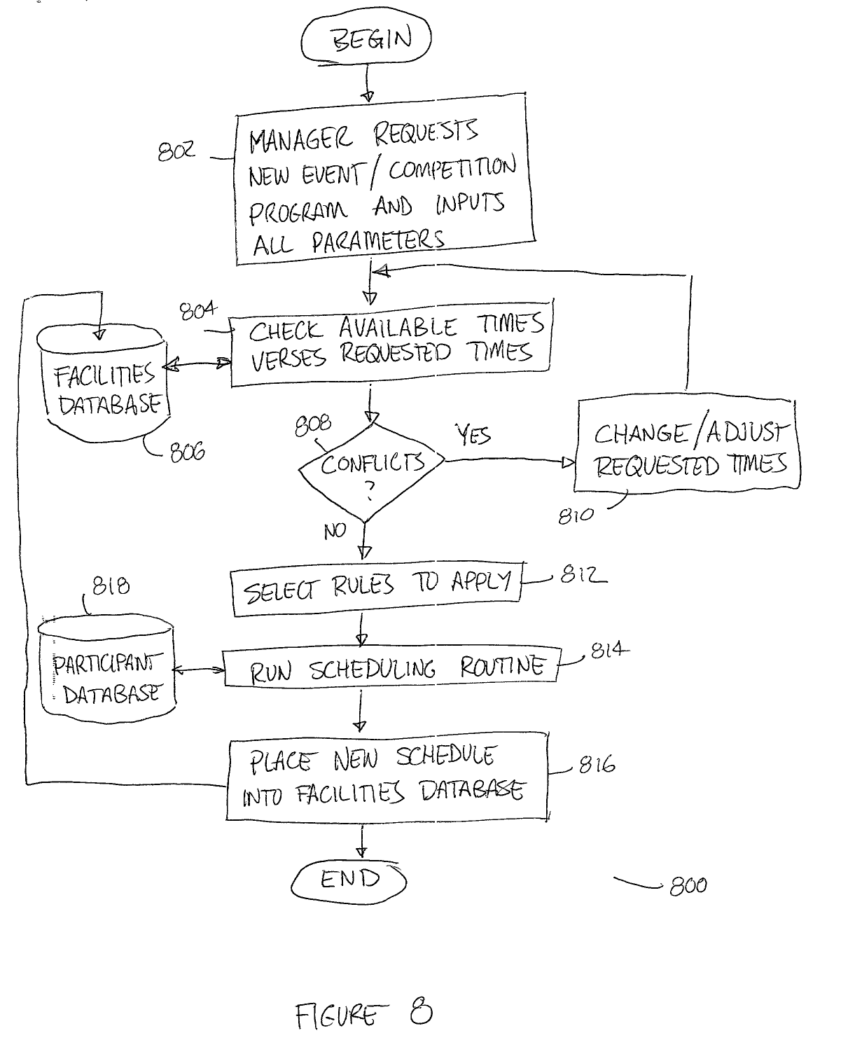

FIG. 8 illustrates an embodiment of the present inventive scheduling method, illustrating a flow chart of the steps in generating a schedule. The league manager requests a new event or competition program and enters the data in block 802 at the beginning of the process. In block 804, the requested time is checked against the facilities database 806 to see available times for the events. If conflicts are present, the league manager may change or adjust requested times in block 810. When the time allotments are finalized, the rules for the particular competition program are selected in block 812. Once the rules are selected, the scheduling routine is run in block 814, using the participant database 818. The output of block 814 is a completed schedule, which is placed into the facilities database 806.

The league manager will typically request the new event of competition program through a web interface. The request may be for a single instance event or a multiple instance program that spans several days, weeks, or months. The request may include the specific date or dates for the event and specific time. Optionally, the request may be for an acceptable range of dates and times. The request may be in the form of the number of weeks for a competition program, the requested days of the week, start times, the number of teams, and the type of competition, such as round robin match play. From these data, the number of start times can be calculated as well as the total time required for each day.

When the times are checked against the facility database, some or all of the events may conflict with requested times. For example, the league manager may request a three-month long competition program that spans a holiday or a period where the venue is down for maintenance. In this case, the manager may be allowed to skip those weeks in conflict or adjust the schedule as needed. For cases where the manager requests a date and time with an acceptable range, the manager may be allowed to review the acceptable times and select the one that is preferred.

The rules that are applied to generate the schedule vary depending on the type of competition. For example, a single session at the facility for a birthday party does not need any rules applied. On the other hand, a double elimination tournament for ten teams on three venues would be quite complex. Other sets of rules may include single elimination tournaments, king of the hill tournaments, round robin match play, etc. The rules may be tailored for each individual sport and each facility.

When the schedule is completed, the information is added to the facilities database 806. This completes the procedure for generating a schedule for a single event or multiple instance program.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of creating a schedule for a sports competition using a computer comprising:
having a database of teams;
selecting scheduling parameters for competition through a web interface;
calculating individual games between each team automatically; and
displaying said schedule through a web interface.

2. The method of claim 1 wherein said scheduling parameters comprise the dates and times of competition.

3. The method of claim 1 wherein said automatic calculation comprises matching each team to another.

4. A computer system for scheduling of sports competitions comprising:
a database of participants,
an automated program for matching participants in games based on a set of rules and thereby creating a schedule of competition, and
a display that provides scheduling information.

5. A computer system for managing a sports facility comprising:
a web server,
a database comprising the schedule for said facility,
a web-based interface for accessing and reserving time in said database.

6. The system of claim 5 further comprising a database of participants and adapted to automatically match said participants into individual competitions.

7. The system of claim 6 further adapted to creating tournament competitions.

8. The system of claim 7 further comprising a website through which said participants can access said schedule.

9. The system of claim 8 wherein statistics on said participants may be kept in said database of participants.
